(19) United States
(12) Patent Application Publication
(10) Pub. No.: US 2004/0192404 A1
(43) Pub. Date: Sep. 30, 2004

(54) Activation system and method for establishing a cellular voice communication through a radio system

(76) Inventors: Marios Zenios, Lake Zurich, IL (US); James A. Van Bosch, Crystal Lake, IL (US)

Correspondence Address: MOTOROLA, INC., 1303 EAST ALGONQUIN ROAD, IL01/3RD, SCHAUMBURG, IL, 60196

(21) Appl. No.: 10/180,576

(22) Filed: Jun. 26, 2002

(51) Int. Cl. H04Q 7/20; H04B 1/40

(52) U.S. Cl. 455/569.1; 455/74

(57) ABSTRACT

An activation system (20, 120) and method for establishing a voice communication through a radio system (22, 122) in a vehicle. The activation system (20, 120) includes a remote activation device (24, 124) and a wireless communication device (26). The remote activation device (24, 124) has a switch (38, 138) and a transmitter (40, 140). The transmitter (40, 140) is responsive to the switch (38, 138) and capable of transmitting an activation signal (A) such as an FM signal. The wireless communication device (26) has a controller (54), a radio transceiver (56), and a cellular transceiver (58). The controller (54) is capable of detecting the activation signal (A) from the remote activation device (24, 124) through the radio transceiver (56). The cellular transceiver (58) is used for receiving the downlink audio of the voice communication. The controller (54) in the wireless communication device (26) sends the downlink audio of the voice communication received by the cellular transceiver (58) to the radio transceiver (56) for transmittal to the radio system (22, 122) in response to detecting the activation signal (A) from the remote activation device (24, 124).

### CROSS-REFERENCE TO RELATED APPLICATION

This application is related to the following co-pending and commonly assigned patent application, which is hereby incorporated by reference herein: Application Serial No. _______, entitled “ACTIVATION SYSTEM AND METHOD FOR ESTABLISHING A CELLULAR VOICE COMMUNICATION THROUGH A RADIO SYSTEM,” filed on same date herewith, by James A. Van Bosch, Attorney Docket Number TC00166.

### FIELD OF THE INVENTION

This invention in general relates to hands-free cellular communication systems and, more particularly, to an activation system and method for establishing a voice communication through a vehicle radio system that reduces the number of distractions to a vehicle operator.

### BACKGROUND OF THE INVENTION

Today, many people use portable phones in their vehicles. For safety reasons, the industry is focused on providing hands-free features to people who use portable phones in their vehicle. Some portable phones allow the audio output of the phone to be routed to the radio system in the vehicle. One known way to route the audio output of the phone to the radio system is through a wireless connection, such as a frequency modulated (FM) signal. There, the portable phone has an FM transmitter that transmits the audio output of the portable phone to the vehicle's radio system. The vehicle's radio system allows the audio output to be played through the vehicle's audio speakers when the radio system is tuned to a predetermined radio frequency.

Conventional systems, however, require at least a two-step process for answering an incoming cellular phone call. First, the user must tune the radio in the vehicle to a compatible radio frequency. Second, the user must answer the call via the cell phone's user interface. Although it is possible for a user of some phones to set the portable phone to automatically answer incoming calls and transmit the audio output automatically through a FM transmitter to the vehicle's radio system, the situation is not ideal since the user may not be ready to receive the phone call and the radio system may not yet be tuned to a compatible radio frequency to hear the audio output.

There is a need to reduce the number of steps in answering an incoming cellular phone call in the vehicle. Reducing the number of steps allows the user of the vehicle to focus on their primary role—driving the vehicle. Additionally, there is a need for improving the way a voice communication is established in a hands-free cellular communication system that reduces the number of distractions to the user.

It is, therefore, desirable to provide an improved hands-free cellular communication system and method to overcome or minimize most, if not all, of the preceding problems.

### BRIEF DESCRIPTION OF THE DRAWINGS

FIG. 1 is a perspective view of an activation system according to one embodiment of the present invention in a vehicle;

FIG. 2 is a block diagram of a remote activation device according to one embodiment of the present invention;

FIG. 3 is a block diagram of a remote activation device, a wireless communication device, and a radio system according to one embodiment of the present invention;

FIG. 4 is a flow diagram of a method according to one embodiment of the present invention;

FIG. 5 is a perspective view of another embodiment of an activation system according to the present invention; and

FIG. 6 is a block diagram of another embodiment of a remote activation device, a wireless communication device, and a radio system according to the present invention.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the appended claims.

### DETAILED DESCRIPTION

What is described is an activation system and method for establishing a voice communication through a radio system that reduces the number of distractions to the vehicle operator. The system and method reduces the complexity and the number of distractions when answering or establishing a cellular communication.

To this end, in one embodiment there is an activation system for establishing a voice communication through a radio system in a vehicle. The activation system includes a remote activation device and a wireless communication device. The remote activation device has a switch and a transmitter. The transmitter is responsive to the switch and capable of transmitting an activation signal such as an FM signal. The wireless communication device has a controller, a radio transceiver, and a cellular transceiver. The controller is capable of detecting the activation signal from the remote activation device through the radio transceiver. The cellular transceiver is used for receiving downlink audio of the voice communication. The controller in the wireless communication device sends the downlink audio of the voice communication received by the cellular transceiver to the radio transceiver for transmittal to the radio system in response to detecting the activation signal from the remote activation device.

In one embodiment, the radio system in the vehicle has a radio frequency selector with a plurality of selector buttons for tuning the radio system to a particular frequency. The remote activation device is coupled to at least one of the selector buttons of the radio frequency selector. In another embodiment, the remote activation device is not coupled to a selector button but is capable of transmitting a second signal to the radio system. In this embodiment, the radio system has a controller that is capable of detecting the second signal and tunes the radio system to a particular frequency in response to detecting the second signal.

In another embodiment, there is a remote activation device for establishing a voice communication for a wireless communication device. The remote activation device has a housing, a transmitter and a switch. The housing is capable of being coupled to a radio frequency selector of a radio system. The transmitter is within the housing for transmitting a signal to the wireless communication device. The signal is capable of causing the wireless communication device to accept an incoming voice communication. The switch is used to activate the transmitter.

A further embodiment is a remote activation device for establishing a voice communication for a wireless communication device through a radio system that has a switch and a transmitter. The transmitter is responsive to the switch for transmitting a first signal and a second signal. The first signal indicates to the wireless communication device to accept an incoming voice communication. The second signal indicates to the radio system to tune the radio system to a particular frequency. The tuned frequency is a frequency that is capable of receiving radio communications from the wireless communication device.

There is also a method to activate a downlink audio of a voice communication through a radio system in a vehicle. The method includes the steps of: notifying the user of a pending incoming voice communication to a wireless communication device; transmitting a first signal from a remote activation device to the wireless communication device if the pending incoming voice communication is accepted; detecting the first signal in the wireless communication device form the remote activation device; and transmitting the downlink audio of the voice communication from the wireless communication device to the radio system after detecting the first signal from the remote activation device. In one embodiment, the radio system has a radio frequency selector that has a plurality of selector buttons for tuning the radio system to a particular frequency. The remote activation device is coupled to at least one of the selector buttons such that the step of transmitting the first signal is done simultaneously with tuning the radio system to a particular frequency. In another embodiment, the method further includes the steps of: transmitting a second signal from the remote activation device to the radio system if the pending incoming voice communication is accepted; detecting the second signal in the radio system from the remote activation device; and tuning the radio system to a particular frequency in response to detecting the second signal.

There is also a method to activate a downlink audio of a voice communication through a radio system in a vehicle having the following steps: notifying the user of a pending incoming voice communication to a wireless communication device; determining whether the pending incoming voice communication should be accepted by waiting for a predetermined time period for a signal from a remote activation device; if the pending incoming voice communication is not accepted, then transferring the downlink audio of the voice communication to an electronic voice answering service; and if the pending incoming voice communication is accepted, then transferring the downlink audio of the voice communication to a radio transceiver in the wireless communication device and transmitting the voice communication to the radio system through the radio transceiver.

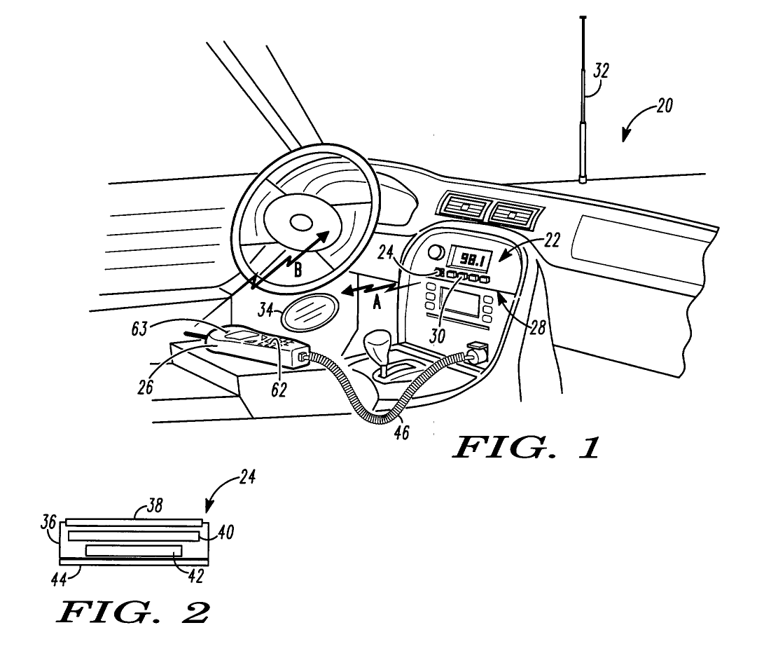

Now, turning to the drawings, FIG. 1 illustrates one embodiment of an activation system 20 for establishing a voice communication through a radio system 22 in a vehicle. In general, the activation system 20 includes a remote activation device 24 and a wireless communication device 26.

In one embodiment, the remote activation device 24 is physically attached to the vehicle radio system 22. In particular, the vehicle radio system 22 may have a radio frequency selector 28 having a plurality of selector buttons 30. The selector buttons 30 are configurable by the operator of the vehicle to tune the radio system 22 to a particular radio frequency. When tuned to a particular radio frequency, the radio system 22 uses an antenna 32 to receive radio signals according to the selected frequency. The radio system 22 then uses the received radio signals to produce an audio output to the vehicle speakers 34. The embodiment illustrated in FIG. 1 shows the remote activation device 24 attached to one of the selector buttons 30 of the radio system 22.

FIG. 2 shows a block diagram of one embodiment of a remote activation device 24. In this embodiment, the remote activation device 24 has an outer housing 36, a switch 38, a transmitter 40, and a power supply 42. The housing 36 of the remote activation device 24 may be used to house the switch 38, the transmitter 40, and the power supply 42. The housing 36 of the remote activation device 24 may also be used to attach the device to a selector button 30 of the radio frequency selector 28. In one embodiment, a double-sided adhesive tape 44 is used to attach the housing 36 to the selector buttons 30. The power supply 42 may be a lithium battery that provides power to the transmitter 40 when the vehicle operator activates the switch 38.

The operator of the vehicle may activate the switch 38 when the operator desires to accept a pending incoming cellular voice communication or to place an outgoing cellular voice communication. As will be explained in more detail below, the transmitter 40 is responsive to the switch 38 and is capable of transmitting an activation signal A to the wireless communication device 26 when the operator of the vehicle presses the switch 38. In one embodiment, the activation signal A is a radio frequency signal such as an FM (frequency modulation) signal. The remote activation device 24 is also physically attached to one of the selector buttons 30 on the radio system 22. Thus, at the same time the transmitter 40 is transmitting the activation signal A to the wireless communication device 26, the radio system 22 is being directed to tune to a particular radio frequency. The tuned frequency should be a frequency that is capable of receiving radio transmissions from the wireless communication device 26.

The wireless communication device 26 is preferably a cellular phone that is capable of receiving cellular voice communications. The wireless communication device 26 may be powered by an internal battery or through a DC power cord 46 that is connected to an outlet on the vehicle. As will be explained further below, the wireless communication device 26 is also configured to detect and receive the activation signal A transmitted by the remote activation device 24. In response to detecting and receiving the activation signal A transmitted by the remote activation device 24, the wireless communication device 26 will switch, transfer or otherwise route the downlink audio of the cellular voice communication to a radio transceiver in the wireless communication device 26. The radio transceiver will then transmit the downlink audio through a radio communication B so that the antenna 32 of the vehicle radio system 22 may receive it. The wireless communication device 26 may receive the uplink audio for the cellular voice communication through an internal microphone in the device or a separate external microphone in the vehicle that is wired to the wireless communication device 26.

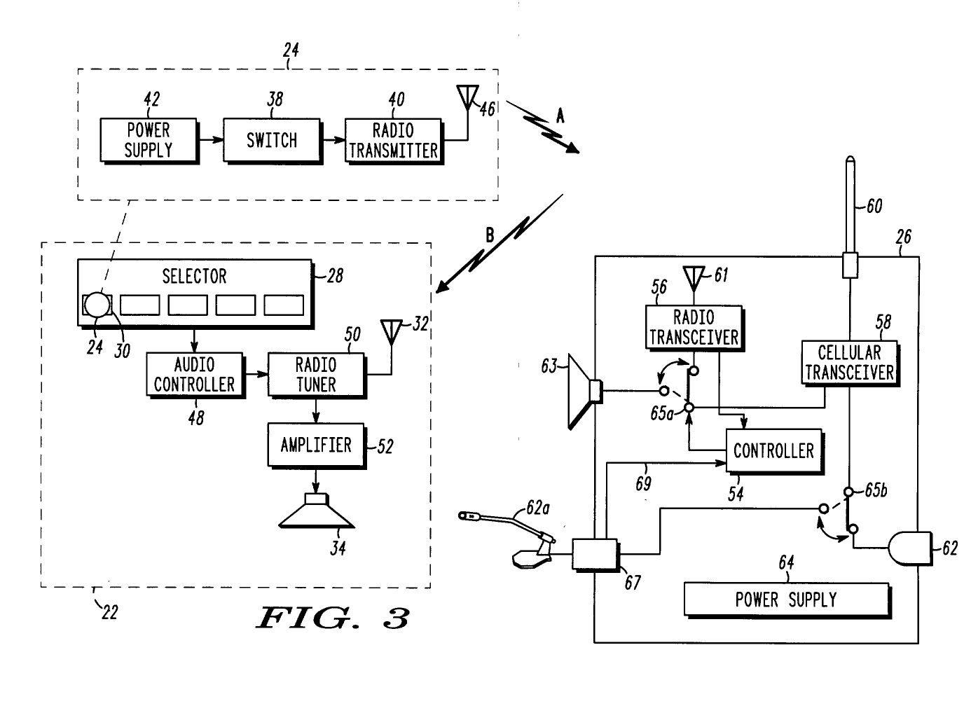

The interaction between the vehicle radio system 22, the remote activation device 24, and the wireless communication device 26 will now be explained in the context of FIG. 3. FIG. 3 illustrates a remote activation device 24 having a switch 38, a transmitter 40, and a power supply 42. The transmitter 40 is responsive to the switch 38 and is capable of transmitting an activation signal A to the wireless communication device 26 when the operator of the vehicle presses the switch 38. As explained earlier, in one embodiment, this activation signal A may be an FM signal. This transmission may be done through an antenna 46 that is internal to the remote activation device 24.

As shown in FIG. 3, the remote activation device 24 is also physically attached to one of the selector buttons 30 of the radio frequency selector 28 on the radio system 22. The radio system 22 generally includes the radio frequency selector 28, the antenna 32, the speakers 34, an audio controller 48, a radio tuner 50, and an amplifier 52. The radio frequency selector 28 is connected to the audio controller 48. When a button 30 is pressed on the radio frequency selector 28, the audio controller 48 will use the radio tuner 50 to tune the radio system 22 to a particular radio frequency. The radio tuner 50 is connected to the antenna 32 to receive signals according to the selected radio frequency and produce an audio signal to the amplifier 52 and the speakers 34.

In one embodiment, the wireless communication device 26 is a cellular phone capable of detecting and receiving cellular voice communications and includes a controller 54, a radio transceiver 56, a cellular transceiver 58, antenna 60, 61, a microphone 62, a speaker 63, and a power supply 64. The wireless communication device 26 may further include other circuitry such as switches 65a, 65b for interconnecting the components within the wireless communication device 26. The switches 65a, 65b may be controlled by the controller 54. The wireless communication device 26 receives downlink audio cellular voice communications and transmits uplink audio cellular voice communications via the cellular transceiver 58 and antenna 60.

The controller 54 is configured according to known methods to monitor the cellular transceiver 58 for pending incoming cellular voice communications. Upon receiving a pending voice communication, the controller 54 will notify the operator of a pending voice communication via an audio or other alert. The controller 54 will then determine whether the vehicle operator will agree to accept the voice communication. In one embodiment, the controller 54 may make this determination by waiting for a predetermined time period to detect whether the remote activation device 24 transmitted an activation signal A. The controller 54 may receive activation signals A through the antenna 61 and radio transceiver 56. If the pending incoming voice communication is not accepted, then the controller 54 can do nothing and let the voice communication transfer to an electronic voice answering service. Alternatively, the controller 54 can respond to the voice communication by sending a special message to the incoming caller that the operator of the vehicle is not able to respond to the call at this time.

If the controller 54 determines that the pending incoming voice communication is accepted (an activation signal A has been detected or received), then the controller 54 may switch, transfer or otherwise route the downlink audio of the voice communication to the radio transceiver 56 so that it can be transmitted to the radio system 22 through the radio transceiver 56. In one embodiment, this can be done by the controller 54 through control of a switch 65a that is capable of connecting the cellular transceiver 58 to the radio transceiver 56. The transmission may then be sent to the radio system 22 via radio communication arrow B. The frequency at which the downlink audio of the voice communication is transmitted to the radio system 22 should match the radio frequency preset by the selector button 30 of the radio frequency selector 28. During normal phone operations (without going through radio transceiver 56), the controller may direct that switch 65a connect the cellular transceiver to the internal speaker 63.

For uplink audio of the voice communication to be transmitted by the cellular transceiver 58, several options exist. In one embodiment, the controller 54 senses the presence of an external microphone 62a in a microphone interface 67 through link 69. When the controller 54 detects the presence of a microphone in the microphone interface 67, and after receiving the activation signal A, the controller 54 may then switch, transfer, or otherwise route the uplink audio of the voice communication from the external microphone 62a to the cellular transceiver 66. In one embodiment, this can be done by the controller 54 through control of a switch 65b that is capable of connecting the external microphone 62a to the cellular transceiver 58. Alternatively, the controller 54 may control the switch 65b so that the cellular transceiver 58 receives uplink audio of the voice communication from the internal microphone 62.

For outgoing communications, the vehicle operator may initiate a cellular voice communication by pressing the switch 38 on the remote activation device 24. As described above, this will do two things. First, the transmitter 40 in the activation device 24 will transmit an activation signal A to the wireless communication device 26. Since no pending calls are being received, the controller 54 will then activate the telephone so that the vehicle operator may dial a number through the keypad on the wireless communication device 26. If the wireless communication device 26 is configured to accept voice recognition commands, the phone number may be dialed through known voice recognition methods. This can be done by having the vehicle operator speak into the device's internal microphone 62 or an externally wired microphone 62a in the vehicle. Second, since the remote activation device 24 in this embodiment is mounted to a selector button 30 on the radio system 22, the radio system 22 will be directed to tune to a particular radio frequency. This should enable the radio system 22 to receive radio transmissions from the wireless communication device 26. The radio transmissions from the wireless communication device 26 would include the downlink audio of the attempted voice communication.

As one of ordinary skill in the art will appreciate, the present invention reduces the number of steps in answering and placing voice communications. With a single push of a button, the radio system 22 is tuned to a certain radio frequency and the wireless communication device 26 is instructed to transmit or otherwise route the downlink audio of the voice communication to the radio system 22. The received downlink audio of the voice communication may then be heard by the vehicle operator over the speakers 34 in the vehicle. The microphone 62 in the wireless communication device 26 may then be used for the uplink audio of the voice communication. Alternatively, an external wired microphone 62a may be used for receiving the uplink audio for the voice communication.

The vehicle operator may also use the remote activation device 24 to terminate a voice communication. During the voice communication, the controller 54 may be configured to wait for or detect a second signal from the remote activation device 24. The second signal may also be an FM signal. When the controller 54 detects or receives the second signal from the remote activation device 24, the controller 54 may terminate the voice communication. This, again, further reduces the number of steps typically known in terminating a hands-free voice communication.

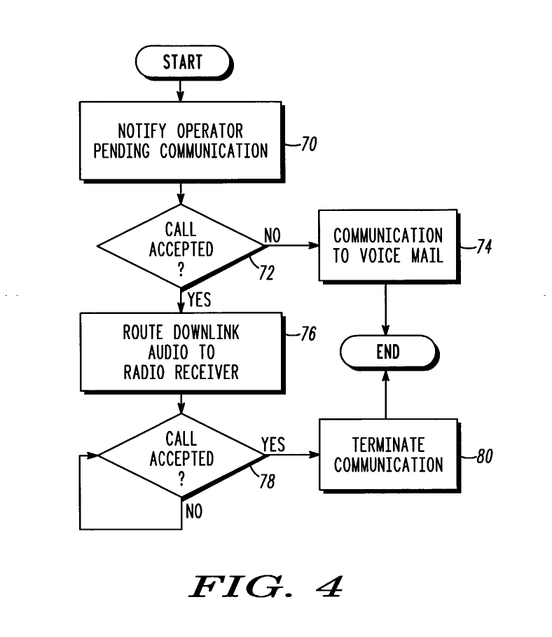

In one embodiment, the controller 54 has a processor that implements software stored in memory. FIG. 4 illustrates one method that may be implemented in software for accepting a voice communication in the wireless communication device 26. The method begins at process block 70 where the wireless communication device 26 receives a pending incoming cellular voice communication. Upon receiving a pending voice communication, the controller 54 notifies the operator of the vehicle that an incoming call is being attempted. The notification may be an audio or visual alert through the wireless communication device 26.

The process then proceeds to decision block 72 where a determination is made whether the pending incoming voice communication should be accepted. This may be done by having the controller 54 wait for or detect during a predetermined time period for a signal A from the remote activation device 24. As shown in block 74, if the pending incoming voice communication is not accepted, then the communication may be directed to an electronic voice mail or answering service. Otherwise, as shown in block 76, if the pending incoming voice communication is accepted, then the downlink audio of the voice communication is switched, transferred or otherwise routed to the radio transceiver 56. This allows the downlink audio of the voice communication to be transmitted to the radio system 22 via radio communication B so that the vehicle operator may hear it over the vehicle speakers 34. The wireless communication device 26 may then receive the uplink audio for the voice communication through an internal microphone 62 or an externally wired microphone 62a.

The process then proceeds to decision block 78 where a determination is made whether the existing voice communication is complete. This may be done by having the controller 54 wait for or detect a second signal A to be transmitted by remote activation device 24. Alternatively, the vehicle operator could terminate the call through the keypad of the wireless communication device 26. The process stays at decision block 78 until the controller 54 makes a determination that the call is complete. At that point, as shown in block 80, the controller 54 then terminates the call and the process ends.

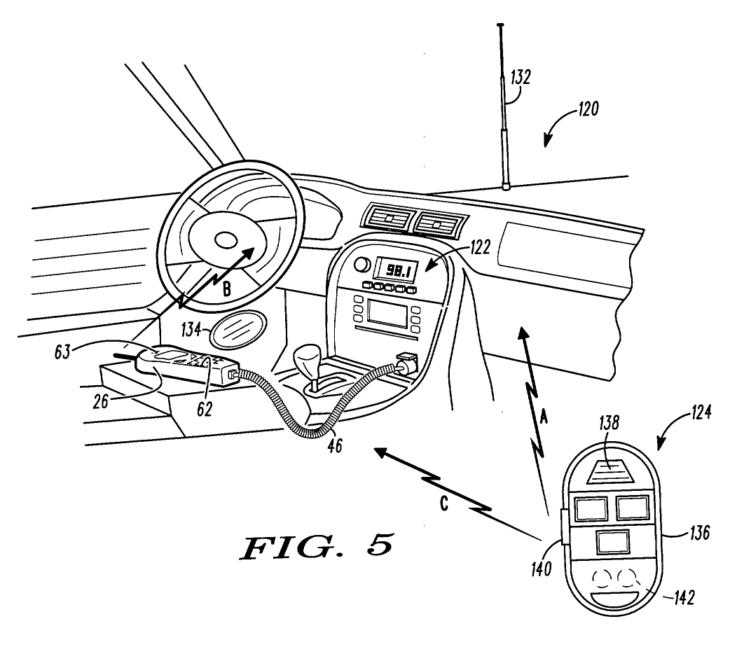

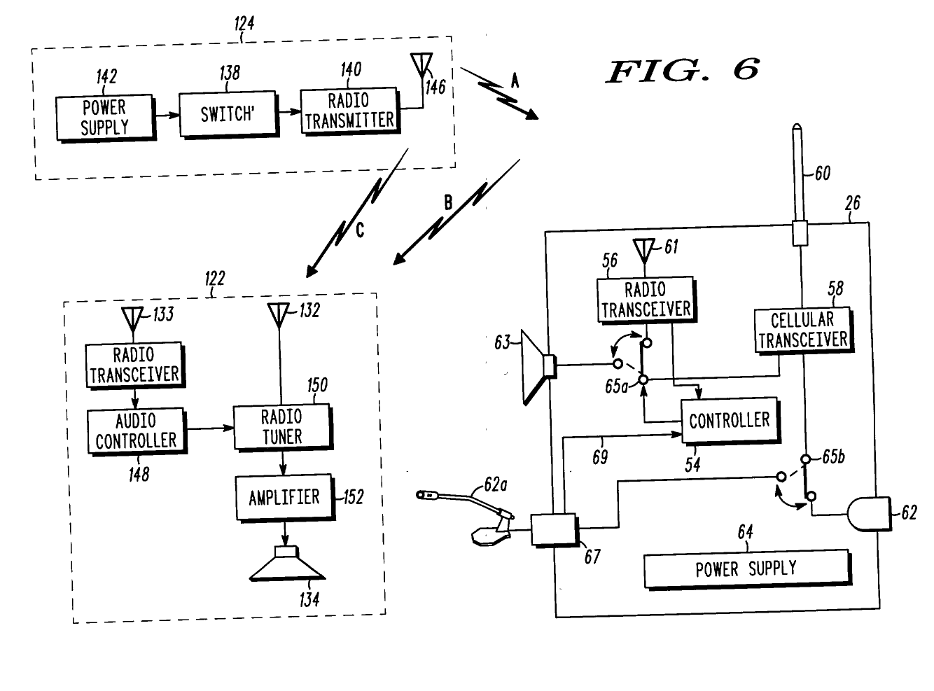

FIGS. 5 and 6 illustrate another embodiment of a remote activation device 124. Referring initially to FIG. 5, the remote activation device 124 is used in the activation system 120 for establishing a voice communication through a radio system 122 in a vehicle. In general, the activation system 120 here includes a remote activation device 124 and a wireless communication device 26. In this embodiment, the remote activation device 124 is not physically attached to the vehicle radio system 122. Instead, the remote activation device 124 may be a separate portable electronic device or integrated into another portable electronic device such as a wireless remote for the vehicle's radio system.

In one embodiment, the remote activation device 124 has an outer housing 136, an activation switch 138, a transmitter 140, and a power supply 142. The housing 136 of the remote activation device 124 may be used to house the activation switch 138, the transmitter 140, and the power supply 142 as well as any other functions or components that may be used by the device. The power supply 142 may be a lithium battery that provides power to the transmitter 140 when the vehicle operator activates the switch 138.

The operator of the vehicle may activate the switch 138 when the operator desires to accept a pending incoming cellular voice communication or to place an outgoing cellular voice communication. As will be explained in more detail below, the transmitter 140 is responsive to the switch 138 and is capable of transmitting a first signal A (or activation signal) to the wireless communication device 26. In one embodiment, the activation signal A is a radio frequency signal such as an FM signal. This first signal A indicates to the wireless communication device to accept an incoming voice communication or set up an outgoing voice communication. The transmitter 140 is also capable of transmitting a second signal C to the radio system 122. The second signal C may also be an FM signal. This second signal C indicates to the radio system 122 to tune to a particular radio frequency so that it can accept radio communications from the wireless communication device 26. Thus, at the same time the transmitter 140 is transmitting the activation signal A to the wireless communication device 26, the radio system 122 is being directed to tune to a particular radio frequency.

As explained above, the wireless communication device 26 is preferably a cellular phone that is capable of receiving cellular voice communications. The wireless communication device 26 may be powered by an internal battery or through a DC power cord 46 that is connected to an outlet on the vehicle. Similar to the embodiment described in FIGS. 1 and 3, the wireless communication device 26 is also configured to detect and receive the first (or activation) signal A transmitted by the remote activation device 124. In response to detecting and receiving the first signal A transmitted by the remote activation device 24, the wireless communication device 26 will switch, transfer, or otherwise route the downlink audio of the cellular voice communications to a radio transceiver in the wireless communication device 26. The radio transceiver will then transmit the downlink audio through a radio transmission B so that it may be received by the antenna 132 of the vehicle radio system 122. The uplink audio for the cellular voice communication may be received by the wireless communication device 26 through a microphone in the device or a separate external microphone wired to the device.

The interaction between the vehicle radio system 122, the remote activation device 124, and the wireless communication device 26 will now be explained in the context of FIG. 6. FIG. 6 illustrates a remote activation device 124 having a switch 138, a transmitter 140, and a power supply 142. The transmitter 140 is responsive to the switch 138 and is capable of transmitting a first signal A to the wireless communication device 26 when the operator of the vehicle presses the switch 138. This transmission may be done through an antenna 146 that is internal to the remote activation device 124 and may be an FM signal.

As shown in FIG. 6, the remote activation device 124 also transmits a second signal C to the radio system 122. The radio system 122 generally includes an antennas 132, 133, the speakers 134, an audio controller 148, a radio tuner 150, a radio transceiver 151, and an amplifier 152. The audio controller 148 will detect and receive signals transmitted from the remote activation device 124 via the radio transceiver 151 and antenna 133. When the audio controller 148 detects and receives the second signal C from the remote activation device 124, the audio controller 148 will use the radio tuner 150 to tune the radio system 122 to a particular radio frequency. The tuned frequency should be a frequency that is capable of receiving radio transmissions from the wireless communication device 26. The radio tuner 150 is connected to the antenna 132 to receive signals according to the selected radio frequency and produce an audio signal to the amplifier 152 and the speakers 134.

Similar to the device shown in FIGS. 1 and 3, the wireless communication device 26 may be a cellular phone capable of receiving cellular voice communications and includes a controller 54, a radio transceiver 56, a cellular transceiver 58, antennas 60, 61, a microphone 62, a speaker 63, and a power supply 64. The wireless communication device 26 may further include other circuitry such as switches 65a , 65b for interconnecting the components within the wireless communication device 26. The switches 65a, 65b may be controlled by the controller 54. The wireless communication device 26 receives downlink audio cellular voice communications and transmits the uplink audio cellular voice communications via the cellular transceiver 58 and antenna 60.

The controller 54 is configured according to known methods to monitor the cellular transceiver 58 for pending incoming cellular voice communications. Upon receiving a pending voice communication, the controller 54 will notify the operator of a pending voice communication via an audio or other alert. The controller 54 will then determine whether the vehicle operator will agree to accept the voice communication. In one embodiment, the controller 54 may make this determination by waiting for a predetermined time period to detect whether the remote activation device 124 transmitted the first signal A. The controller 54 may receive activation signals A through the antenna 61 and radio transceiver 56. If the pending incoming voice communication is not accepted, then the controller 54 can do nothing and let the voice communication transfer to an electronic voice answering service. Alternatively, the controller 54 can respond to the voice communication by sending a special message to the incoming caller that the operator of the vehicle is not able to respond to the call at this time.

If the controller 54 determines that the pending incoming voice communication is accepted (a first signal A has been received), then the controller 54 may switch, transfer, or otherwise route the downlink audio of the voice communication to the radio transceiver 56 so that it can be transmitted to the radio system 122 through the radio transceiver 56. In one embodiment, this can be done by the controller 54 through control of a switch 65a that is capable of connecting the cellular transceiver 58 to the radio transceiver 56. The transmission may then be sent to the radio system 122 via radio communication arrow B. The frequency at which the downlink audio of the voice communication is transmitted to the radio system 122 should match the radio frequency selected by the audio controller 148. During normal phone operations (without going through radio transceiver 56), the controller 54 may direct that switch 65a connect the cellular transceiver 58 to the internal speaker 63.

For uplink audio of the voice communication to be transmitted by the cellular transceiver 58, several options exist. In one embodiment, the controller 54 senses the presence of an external microphone 62a in a microphone interface 67 through link 69. When the controller 54 detects the presence of a microphone in the microphone interface 67, and after receiving the activation signal A, the controller 54 may then switch, transfer, or otherwise route the uplink audio of the voice communication from the external microphone 62a to the cellular transceiver 66. In one embodiment, this can be done by the controller 54 through control of a switch 65b that is capable of connecting the external microphone 62a to the cellular transceiver 58. Alternatively, the controller 54 may control the switch 65b so that the cellular transceiver 58 receives uplink audio of the voice communication from the internal microphone 62.

For outgoing communications, the vehicle operator may initiate a cellular voice communication by pressing the switch 138 on the remote activation device 124. As described above, this will do two things. First, the transmitter 140 in the activation device 124 will transmit first signal A to the wireless communication device 26. Since no pending calls are being received, the controller 54 will then activate the telephone so that the vehicle operator may dial a number through the keypad on the wireless communication device 26. If the wireless communication device 26 is configured to accept voice recognition commands, the phone number may be dialed through known voice recognition methods. This can be done by having the vehicle operator speak into the device's internal microphone 62 or an externally wired microphone 62a. Second, the transmitter 140 in the remote activation device 124 will transmit a second signal C to the radio system 122. The audio controller 148 in the radio system 122 will direct the radio system 122 to tune to a particular radio frequency. This should enable the radio system 122 to receive radio transmissions from the wireless communication device 26. The radio transmissions from the wireless communication device 26 would include the downlink audio of the attempted voice communication.

What has been described is an activation system and method for establishing a voice communication in a hands-free cellular communication system. The system and method reduces the complexity and the number of distractions when answering or establishing a cellular communication. The above description of the present invention is intended to be exemplary only and is not intended to limit the scope of any patent issuing from this application. The present invention is intended to be limited only by the scope and spirit of the following claims.

What is claimed is:

1. An activation system for establishing a voice communication through a radio system in a vehicle, the activation system comprising:
a remote activation device having a switch and a transmitter, the transmitter responsive to the switch and capable of transmitting an activation signal; and
a wireless communication device having a controller, a radio transceiver, and a cellular transceiver, the controller capable of detecting the activation signal from the remote activation device through the radio transceiver, the cellular transceiver for receiving downlink audio of the voice communication;
wherein the controller in the wireless communication device, in response to detecting the activation signal from the remote activation device, sends the downlink audio of the voice communication received by the cellular transceiver to the radio transceiver for transmittal to the radio system in the vehicle.

2. The activation system in claim 1, wherein the radio system in the vehicle has a radio frequency selector having a plurality of selector buttons for tuning the radio system to a particular frequency, the remote activation device being coupled to at least one of the selector buttons of the radio frequency selector.

3. The activation system in claim 1, wherein the remote activation device transmits the activation signal at the same time the radio system tunes to a particular frequency.

4. The activation system in claim 1, wherein the remote activation device is incorporated into a portable electronic device for the vehicle.

5. The activation system in claim 4, wherein the remote activation device is further capable of transmitting a second signal to the radio system.

6. The activation system in claim 5, wherein the radio system has a controller, the controller capable of detecting the second signal and tuning the radio system to a particular frequency in response to detecting the second signal.

7. A remote activation device for establishing a voice communication for a wireless communication device, the remote activation device comprising:
a housing capable of being coupled to a radio frequency selector of a radio system;
a transmitter within the housing for transmitting a signal to the wireless communication device, the signal capable of causing the wireless communication device to accept an incoming voice communication; and
a switch for activating the transmitter.

8. The remote activation device in claim 7, wherein the radio frequency selector has at least one selector button for tuning the radio system to a particular frequency, the remote activation device capable of transmitting the signal at the same time the radio system tunes to the particular frequency.

9. The remote activation device in claim 7, wherein the wireless communication device has a controller, a radio transceiver, and a cellular transceiver, the controller capable of detecting the signal from the remote activation device through the radio transceiver.

10. The remote activation device in claim 9, wherein the controller in the wireless communication device, in response to detecting the signal from the remote activation device, sends downlink audio of the voice communication received by the cellular transceiver to the radio transceiver for transmittal to the radio system.

11. A remote activation device for establishing a voice communication for a wireless communication device through a radio system, the remote activation device comprising:
a switch; and
a transmitter responsive to the switch for transmitting a first signal and a second signal;
wherein the first signal indicates to the wireless communication device to accept an incoming voice communication, and the second signal indicates to the radio system to tune to a particular frequency.

12. The remote activation device in claim 11, wherein the wireless communication device has a controller, a cellular transceiver, and a radio transceiver, the controller capable of detecting the first signal from the remote activation device through the radio transceiver.

13. The remote activation device in claim 12, wherein the controller in the wireless communication device, in response to detecting the first signal from the remote activation device, sends downlink audio of the voice communication received by the cellular transceiver to the radio transceiver for transmittal to the radio system.

14. The remote activation device in claim 11, wherein the radio system has a controller and a radio transceiver, the controller capable of detecting the second signal from the remote activation device through the radio transceiver.

15. The remote activation device in claim 14, wherein the controller in the radio system, in response to detecting the second signal from the remote activation device, tunes the radio system to the particular frequency.

16. A method to activate downlink audio of a voice communication through a radio system in a vehicle, the method comprising the steps of:
notifying the user of a pending incoming voice communication to a wireless communication device;
transmitting a first signal from a remote activation device to the wireless communication device if the pending incoming voice communication is accepted;
detecting the first signal in the wireless communication device from the remote activation device; and
transmitting the downlink audio of the voice communication from the wireless communication device to the radio system after detecting the first signal from the remote activation device.

17. The method in claim 16, wherein the radio system has a radio frequency selector having a plurality of selector buttons for tuning the radio system to a particular frequency, the remote activation device being coupled to at least one of the selector buttons of the radio frequency selector such that the step of transmitting the first signal is done simultaneously with tuning the radio system to the particular frequency.

18. The method in claim 16, wherein the method further includes the steps of:
transmitting a second signal from the remote activation device to the radio system if the pending incoming voice communication is accepted;
detecting the second signal in the radio system from the remote activation device; and
tuning the radio system to a particular frequency in response to detecting the second signal.

19. A method to activate downlink audio of a voice communication through a radio system in a vehicle, the method comprising the steps of:
notifying the user of a pending incoming voice communication to a wireless communication device;
determining whether the pending incoming voice communication should be accepted by waiting for a predetermined time period for a signal from a remote activation device;
if the pending incoming voice communication is not accepted, then transferring the downlink audio of the voice communication to an electronic voice answering service; and
if the pending incoming voice communication is accepted, then transferring the downlink audio of the voice communication to a radio transceiver in the wireless communication device and transmitting the downlink audio of the voice communication to the radio system through the radio transceiver.

20. The method in claim 19, wherein the method further includes the steps of:
determining in the wireless communication device whether the voice communication should be terminated by waiting for a second signal from the remote activation device; and
terminating the voice communication when the wireless communication device receives the second signal from the remote activation device.
